(19) United States
(12) Patent Application Publication
(10) Pub. No.: US 2017/0190623 A1
(43) Pub. Date: Jul. 6, 2017

(54) CLAY-BASED ARTICLES AND METHODS OF MAKING THE SAME

(71) Applicant: Sara Mc Design, LLC, Oakland, CA (US)

(72) Inventors: Travis McFlynn, Oakland, CA (US); John R. Toki, Oakland, CA (US)

(73) Assignee: Sara Mc Design, LLC, Oakland, CA (US)

(21) Appl. No.: 15/397,027

(22) Filed: Jan. 3, 2017

Related U.S. Application Data
(60) Provisional application No. 62/273,575, filed on Dec. 31, 2015.

(51) Int. Cl. C04B 33/04; A47J 36/02; C04B 33/13; A47J 27/00; C04B 33/32; C04B 33/34

(52) U.S. Cl. CPC C04B 33/04; C04B 33/32; C04B 33/34; C04B 33/13; A47J 27/002; A47J 36/02; C04B 2235/349; C04B 2235/3463; C04B 2235/3472; C04B 2235/3445; C04B 2235/3201; C04B 2235/3208; C04B 2235/3206; C04B 2235/3232; C04B 2235/602; C04B 2235/656; C04B 2235/6567; C04B 2235/9607

(57) ABSTRACT

The present disclosure relates to clay-based articles (e.g., articles of cookware) and methods of making the same.

### RELATED APPLICATIONS

This application claims priority to U.S. Provisional Application No. 62/273,575, filed Dec. 31, 2015, which is incorporated herein by reference in its entirety.

### FIELD

The present disclosure relates to clay-based articles (e.g., articles of cookware) and methods for making the same.

### BACKGROUND

While clay-based articles provide aesthetic and other advantages in many applications, they are often unable to withstand heating at high temperatures or rapid changes in temperatures without cracking. Meanwhile, when used for making cookware, materials such as cast-iron, stainless steel, copper, porcelain, and some advanced ceramics may be able to withstand such environments to varying degrees, but carry disadvantages related to weight, aesthetics, corrosiveness, surface reactivity (which can affect food flavor in undesired manners), ability to retain heat and moisture, and durability. Furthermore, methods for making cookware out of those materials may be limited at a practical level to industrial-type processes, such as casting, that eliminate the capacity for the cookware to have a bespoke, individual aesthetic quality, which a clay-based article may have. It would therefore be beneficial to provide articles and methods that address these and/or other drawbacks.

### SUMMARY

In general, this disclosure is directed to clay-based articles, e.g., articles of cookware, and methods for making the same.

According to one or more embodiments, a series of articles are provided. In one embodiment, an article of cookware is provided. The article of cookware comprises a clay body. The clay body comprises water and a clay mixture. The clay mixture comprises hectorite, mullite, petalite, and a base clay.

According to some embodiments, the base clay may comprise aluminum (I) oxide (AlO₂) and silicon dioxide (SiO₂). The clay mixture may comprise 0.1% to 5% by weight hectorite; 0.1% to 5% by weight mullite; 40% to 60% by weight petalite; and 40% to 60% by weight base clay. The base clay may comprise 20% to 50% by weight aluminum (I) oxide (AlO₂) and 30% to 70% by weight silicon dioxide (SiO₂). The base clay may further comprise 0.1% to 5% by weight potassium oxide (K₂O); 0.1% to 5% by weight calcium oxide (CaO); 0.1% to 5% by weight magnesium oxide (MgO); and 0.1% to 5% by weight titanium oxide (TiO₂). The base clay may further comprise 0.1% to 5% iron oxide (Fe₂O₃). The clay body, prior to firing and/or after firing, may comprise 1% to 40% by weight water and 60% to 99% by weight clay mixture.

According to some embodiments, the article may further comprise a glaze coating on at least a portion of a surface of the clay body. The article may further comprise a glaze coating on a surface of the cookware configured to contact food. The glaze coating may have an average thickness of 0.05 mm to 2 mm. The glaze coating may have an average thickness of 0.05 mm to 1 mm. The glaze coating may comprise a non-stick coating. The glaze coating may be substantially non-reactive. The glaze coating and the clay body may have approximately the same coefficient of thermal expansion.

According to some embodiments, the article of cookware may be configured to tolerate preparation, storage, cooking, and serving temperatures up to and greater than 1100° F. The article of cookware may be configured to tolerate temperatures greater than 1500° F. The article of cookware may be configured to tolerate temperatures greater than 1800° F. The article of cookware may be configured to tolerate temperatures greater than 2000° F. The article of cookware may be configured to tolerate temperatures greater than 2200° F. The article of cookware may comprise ceramic.

According to one or more embodiments, a series of methods are provided. In one embodiment, a method for making an article of cookware is provided. The method may comprise providing a clay body, shaping the clay body, and firing the shaped clay body to produce the article of cookware. The clay body comprises water and a clay mixture. The clay mixture comprises hectorite, mullite, petalite, and a base clay.

According to some embodiments, the base clay may comprise aluminum (I) oxide (AlO₂) and silicon dioxide (SiO₂). The clay mixture may comprise: 0.1% to 5% by weight hectorite; 0.1% to 5% by weight mullite; 40% to 60% by weight petalite; and 40% to 60% by weight base clay. The base clay may comprise 20% to 50% by weight aluminum (I) oxide (AlO₂) and 30% to 70% by weight silicon dioxide (SiO₂). The base clay may further comprise: 0.1% to 5% by weight potassium oxide (K₂O); 0.1% to 5% by weight calcium oxide (CaO); 0.1% to 5% by weight magnesium oxide (MgO); and 0.1% to 5% by weight titanium oxide (TiO₂). The base clay may further comprise 0.1% to 5% iron oxide (Fe₂O₃). The clay body, prior or subsequent to firing, may comprise 1% to 40% by weight water and 60% to 99% by weight clay mixture.

According to some embodiments, the method may further comprise glazing the shaped clay body. According to some embodiments, the step of glazing may comprise applying a first clear glaze, and applying a second stained glaze. The step of glazing may comprise applying a first clear glaze to the shaped clay body after a first firing and before a second firing; and applying a second stained glaze to the shaped clay body, after a first firing and before a second firing.

According to some embodiments, the step of providing the clay body may comprise: mixing the clay mixture; milling the clay mixture; adding the water to the clay mixture to produce a wet mixture; and de-airing the wet mixture to provide a clay body.

According to some embodiments, the step of shaping may comprise throwing the clay body on a pottery wheel. The step of shaping may comprise one of molding, slip-casting, dry-pressing, and ram-pressing.

According to some embodiments, the step of firing may comprise firing at a temperature of between 2000° F. and 2300° F. The step of firing may comprise: firing the shaped clay body in a kiln for 4 to 10 hours at between 150° F. and 250° F.; increasing the temperature at a rate of between 100° F./hr. and 300° F./hr. until reaching a temperature of between 1800° F. and 2000° F.; allowing the shaped clay body to cool for a period of at least 12 hours; firing the shaped clay body at an increasing temperature from a starting temperature of between 40° F. and 250° F. for a period of 6 to 10 hours until reaching a temperature between 2000° F. and 2300° F.; and allowing the shaped clay body to cool for a period of at least 12 hours.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic, top view of an article of cookware, according to at least one embodiment of the present disclosure; and

FIG. 1B is a schematic, side, cross-sectional view taken along the axis A-A′ of the article of cookware of FIG. 1A, according to at least one embodiment of the present disclosure.

### DETAILED DESCRIPTION

According to one or more embodiments, the present disclosure relates to clay-based articles, and methods of making the same. For example, the articles may be articles of cookware. Articles of cookware may be understood to include any article suitable for preparing, cooking, heating, serving, or storing food. The articles may be resistant to cracking at high temperatures and/or when subjected to sudden extreme temperature changes.

According to one or more embodiments, the articles have a unique composition for clay-based cookware allowing for several advantages over other cookware. The disclosed cookware may be aesthetically-pleasing and suitable for commercial and residential kitchens and service environments. In some embodiments, the clay-based articles are custom-designed and individually produced by hand on a potter's wheel, molded, (e.g., hand pressed in a mold or over a drape mold). In some embodiments, the articles may be shaped using other techniques including, without limitation, slip-casting, dry-pressing, or ram-pressing. In some embodiments, the cookware is durable and able to withstand extremely high temperatures without cracking, for example, temperatures of greater than 1100° F., greater than 1500° F., greater than 1800° F., greater than 2000° F., or greater than 2200° F. Likewise, the articles may sustain rapid changes in temperature, for example, plunging the cookware while in a white hot state into an ice-water bath, without cracking. In addition to other advantages offered by the cookware, its durability provides economic advantages over other cookware that needs to be replaced more often.

According to one or more embodiments, the article of cookware may be unitary, or may comprise more than one distinct pieces. For example, the cookware may comprise a primary vessel and a corresponding separate lid to cover the vessel.

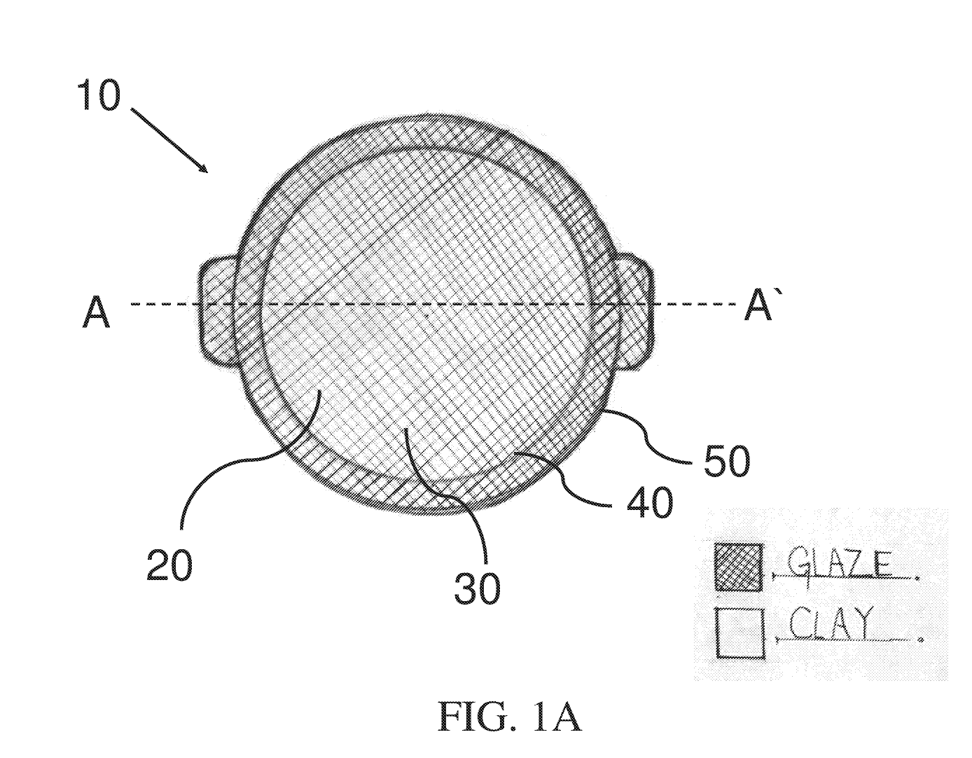

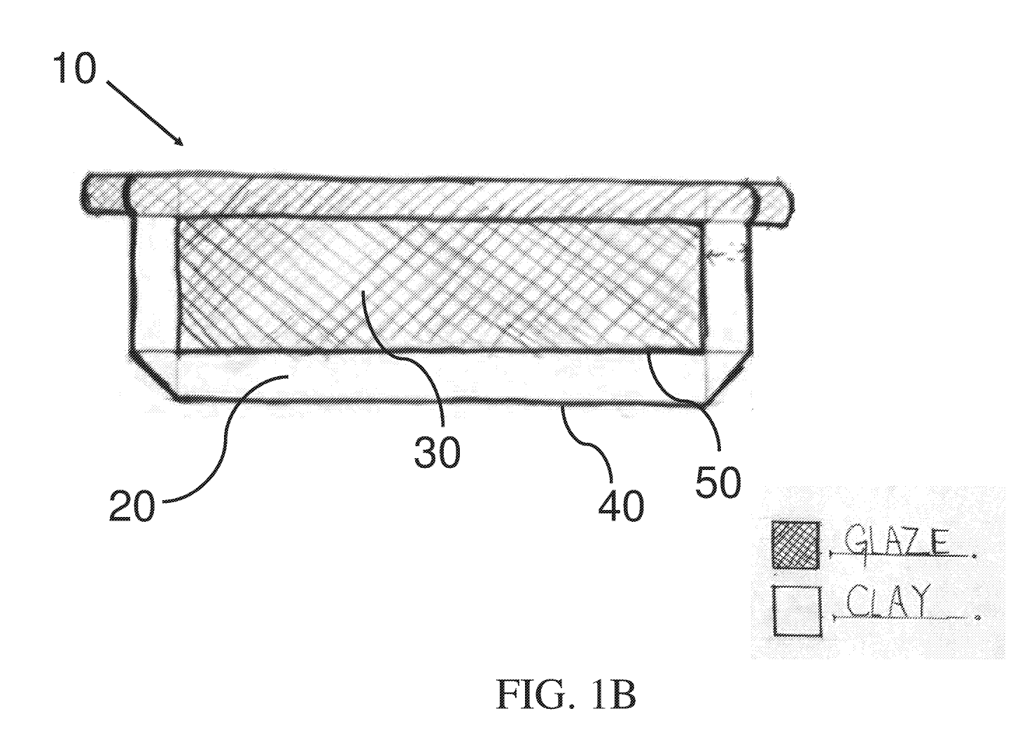

FIG. 1A shows a top view of an article of cookware 10, according to at least one embodiment of the present disclosure. FIG. 1B shows a cross-sectional view taken along the axis A-A′ of the article of cookware 10 of FIG. 1A. As shown in the FIGS. the article of cookware 10 comprises a clay body 20 and a glaze 30 coating a portion of a surface of the clay body 20. In the article of cookware 10 shown in FIGS. 1A and 1B, the glaze 30 coats an interior surface 40 of the article 10, while an exterior surface 50 is unglazed. According to certain embodiments, the portion of the surface that is expected to come into contact with food is the portion that is glazed. According to certain embodiments, the unglazed surface portion is a bottom portion that will contact a source of heat, such as a stove top. Aspects and characteristics of the cookware 10 and its components, as well as methods for making the cookware, are described in detail below. According to alternative embodiments, a glaze may cover the entire surface of the cookware. According to alternative embodiments, no glaze is applied to the cookware.

Aspects of the articles' composition and design may contribute to improved cooking characteristics. For example, the porosity of the clay body 20 contributes to improved moisture retention during the cooking process. The glaze 30 may make the surface to which it is applied a non-stick surface, aiding in both cooking and in cleaning the cookware 10. Meanwhile, according to some embodiments, an unglazed underside of the article may allow the cookware to absorb varying amounts of moisture, which may improve the cooking process. Heat retention/insulation qualities of the clay body 20 may allow for even, penetrative cooking, also referred to as “far infrared radiation” cooking. Likewise, the insulation qualities of the cookware 10 aid in maintaining handles at temperatures cool to the touch in some circumstances. The cookware 10 may be formed from non-toxic materials to ensure food safety and quality. According to certain embodiments the glaze 30 may be non-reactive allowing for certain types of foods, for example, acidic foods, to be made without damaging the cookware or the ingredients, thereby contributing to a purer flavor. The clay-based cookware 10 may also be lighter than other types of cookware, for example, cast-iron cookware.

Examples of the articles of cookware 10 may include any cookware found in a home or restaurant, including, without limitation, pots, pans, grills, pizza stones, roasting trays, dutch ovens, sauce pans, ramekins, plates, bowls, cazuelas, woks, tagines, cloches, comals, donabes. The cookware may be suitable for use with a variety of sources of heat including, without limitation, open flame, microwave, stove and/or oven including, gas, electric, wood, or charcoal-fired oven, etc. The cookware 10 may be used in a variety of environments, including, without limitation: on a gas or electric range; in the oven as a baking dish; in the oven under a broiler; in a barbeque over coals or wood fire; in a microwave oven; for boiling water; for heating food directly from the refrigerator to the stove top; as a serving container/platter; etc. The cookware 10 may be dishwasher safe and/or cleaned with soap and/or water, or by other methods.

### COMPOSITION OF COOKWARE

According to certain embodiments, the clay body may comprise a clay mixture and water. According to one or more embodiments, the clay mixture may comprise a mineral-enriched base clay. The clay mixture may comprise in various proportions by weight hectorite, mullite, petalite, and a base clay.

The base clay may comprise any suitable clay. The base clay may comprise a fire clay, a clay capable of withstanding high temperatures. According to one or more embodiments, the base clay may comprise aluminum (I) oxide (AlO₂) and silicon dioxide (SiO₂). The base clay may further comprise potassium oxide (K₂O); calcium oxide (CaO); magnesium oxide (MgO); titanium oxide (TiO₂); and iron oxide (Fe₂O₃), as well as other components.

### RANGES OF THE CLAY MIXTURE

In some embodiments, the clay body may comprise a certain percentage by weight of the clay mixture, before or after firing. In some embodiments, the clay body has a percentage of clay mixture by weight of at least 60%, at least 65%, at least 70%, at least 75%, at least 80%, at least 85%, at least 90%, or at least 95%. In some embodiments, the clay body has a percentage of clay mixture by weight of less than or equal to 99%, of less than or equal to 95%, of less than or equal to 90%, less than or equal to 85%, less than or equal to 80%, less than or equal to 75%, less than or equal to 70%, or less than or equal to 65%. Combinations of the above-referenced ranges are also possible (e.g., at least 70% and less than 90%). Other values and ranges are also possible, depending on methods of manufacture and shaping of the clay body.

Hectorite

In some embodiments, the clay mixture may comprise a certain percentage by weight of hectorite. Hectorite is added to the clay body to increase plasticity, adding to the workability of the material during the manufacturing process.

In some embodiments, the clay mixture has a percentage of hectorite by weight of at least 0.1%, at least 1.0%, at least 2.0%, at least 3.0%, or at least 4.0%. In some embodiments, the clay mixture has a percentage of hectorite by weight of less than or equal to 5.0%, less than or equal to 4.0%, less than or equal to 3.0%, less than or equal to 2.0%, or less than or equal to 1.0%. Combinations of the above-referenced ranges are also possible (e.g., at least 0.1% and less than or equal to 5%). Other values and ranges are also possible.

Mullite

In some embodiments, the clay mixture may comprise a certain percentage by weight of mullite. Mullite's main purpose is to prevent the fired clay from cracking when subjected to uneven heat, such as when a red hot piece of clay is plunged into cold water, or set into a freezer. Mullite helps to prevent the clay from warping during drying and firing, and adds to the overall strength of the fired clay.

In some embodiments, the clay mixture has a percentage of mullite by weight of at least 0.1%, at least 1.0%, at least 2.0%, at least 3.0%, or at least 4.0%. In some embodiments, the clay mixture has a percentage of mullite by weight of less than or equal to 5.0%, less than or equal to 4.0%, less than or equal to 3.0%, less than or equal to 2.0%, or less than or equal to 1.0%. Combinations of the above-referenced ranges are also possible (e.g., at least 0.1% and less than or equal to 5%). Other values and ranges are also possible.

Petalite

In some embodiments, the clay mixture may comprise a certain percentage by weight of petalite. Petalite's main purpose is to impart thermal shock resistance to the fired clay body. It has almost zero expansion when heated above 700° C. (1292° F.).

In some embodiments, the clay mixture has a percentage of petalite by weight of at least 40%, at least 45%, at least 50%, or at least 55%. In some embodiments, the clay mixture has a percentage of petalite by weight of less than or equal to 60%, less than or equal to 55%, less than or equal to 50%, or less than or equal to 45%. Combinations of the above-referenced ranges are also possible (e.g., at least 40% and less than or equal to 60%). Other values and ranges are also possible.

Base Clay

In some embodiments, the clay mixture may comprise a certain percentage by weight of base clay. The base clay may be any suitable clay. According to certain embodiments, the base clay may be a high fire clay that adds to the workability/plasticity of the clay body. It also adds to the fired strength of the clay body, making the clay able to be fired at over 2000° F. without slumping or warping.

In some embodiments, the clay mixture has a percentage of base clay by weight of at least 40%, at least 45%, at least 50%, or at least 55%. In some embodiments, the clay mixture has a percentage of base clay by weight of less than or equal to 60%, less than or equal to 55%, less than or equal to 50%, or less than or equal to 45%. Combinations of the above-referenced ranges are also possible (e.g., at least 40% and less than or equal 60%). Other values and ranges are also possible.

### COMPONENTS OF THE BASE CLAY

Aluminum (I) Oxide (AlO₂)

In some embodiments, the base clay may comprise a certain percentage by weight of aluminum (I) oxide (AlO₂). In some embodiments, the base clay has a percentage of aluminum (I) oxide (AlO₂) by weight of at least 20%, at least 25%, at least 30%, at least 35%, at least 40%, or at least 45%. In some embodiments, the base clay has a percentage of aluminum (I) oxide (AlO₂) by weight of less than or equal to 50%, less than or equal to 45%, less than or equal to 40%, less than or equal to 35%, less than or equal to 30%, or less than or equal to 25%. Combinations of the above-referenced ranges are also possible (e.g., at least 20% and less than or equal to 50%). Other values and ranges are also possible.

Silicon Dioxide (SiO₂)

In some embodiments, the base clay may comprise a certain percentage by weight of silicon dioxide (SiO₂). In some embodiments, the base clay has a percentage of silicon dioxide (SiO₂) by weight of at least 30%, at least 40%, at least 50%, at least 60%, or at least 65%. In some embodiments, the base clay has a percentage of silicon dioxide (SiO₂) by weight of less than or equal to 70%, less than or equal to 65%, less than or equal to 60%, less than or equal to 50%, or less than or equal to 40%. Combinations of the above-referenced ranges are also possible (e.g., at least 30% and less than or equal to 70%). Other values and ranges are also possible.

Potassium Oxide (K₂O)

In some embodiments, the base clay may comprise a certain percentage by weight of potassium oxide (K₂O). In some embodiments, the base clay mixture has a percentage of potassium oxide (K₂O) by weight of at least 0.1%, at least 1.0%, at least 2.0%, at least 3.0%, or at least 4.0%. In some embodiments, the base clay has a percentage of potassium oxide (K₂O) by weight of less than or equal to 5.0%, less than or equal to 4.0%, less than or equal to 3.0%, less than or equal to 2.0%, or less than or equal to 1.0%. Combinations of the above-referenced ranges are also possible (e.g., at least 0.1% and less than or equal to 5.0%). Other values and ranges are also possible.

Calcium Oxide (CaO)

In some embodiments, the base clay may comprise a certain percentage by weight of calcium oxide (CaO). In some embodiments, the base clay has a percentage of calcium oxide (CaO) by weight of at least 0.1%, at least 1.0%, at least 2.0%, at least 3.0%, or at least 4.0%. In some embodiments, the base clay has a percentage of calcium oxide (CaO) by weight of less than or equal to 5.0%, less than or equal to 4.0%, less than or equal to 3.0%, less than or equal to 2.0%, or less than or equal to 1.0%. Combinations of the above-referenced ranges are also possible (e.g., at least 0.1% and less than or equal to 5.0%). Other values and ranges are also possible.

Magnesium Oxide (MgO)

In some embodiments, the base clay may comprise a certain percentage by weight of magnesium oxide (MgO). In some embodiments, the base clay has a percentage of magnesium oxide (MgO) by weight of at least 0.1%, at least 1.0%, at least 2.0%, at least 3.0%, or at least 4.0%. In some embodiments, the base clay has a percentage of magnesium oxide (MgO) by weight of less than or equal to 5.0%, less than or equal to 4.0%, less than or equal to 3.0%, less than or equal to 2.0%, or less than or equal to 1.0%. Combinations of the above-referenced ranges are also possible (e.g., at least 0.1% and less than or equal to 5.0%). Other values and ranges are also possible.

Titanium Oxide (TiO₂)

In some embodiments, the base clay mixture may comprise a certain percentage by weight of titanium oxide (TiO₂). In some embodiments, the base clay mixture has a percentage of titanium oxide (TiO₂) by weight of at least 0.1%, at least 1.0%, at least 2.0%, at least 3.0%, at least 4.0%, or at least 5.0%. In some embodiments, the base clay mixture has a percentage of titanium oxide (TiO₂) by weight of less than or equal to 5.0%, less than or equal to 4.0%, less than or equal to 3.0%, less than or equal to 2.0%, less than or equal to 1.0%, or less than or equal to 0.1%. Combinations of the above-referenced ranges are also possible (e.g., at least 0.1% and less than or equal to 5.0%). Other values and ranges are also possible.

Iron Oxide

In some embodiments, the base clay may comprise a certain percentage by weight of an iron oxide species, (e.g., Fe₂O₃). In some embodiments, the base clay mixture has a percentage of iron oxide by weight of at least 0.1%, at least 1.0%, at least 2.0%, at least 3.0%, or at least 4.0%. In some embodiments, the base clay mixture has a percentage of iron oxide by weight of less than or equal to 5.0%, less than or equal to 4.0%, less than or equal to 3.0%, less than or equal to 2.0%, or less than or equal to 1.0%. Combinations of the above-referenced ranges are also possible (e.g., at least 0.1% and less than or equal to 5.0%). Other values and ranges are also possible.

The inclusion of additional ingredients or impurities is also considered within the scope of the invention. For example, in some embodiments small percentages of additional dyes or clays may be included at various stages of the process to alter the color of the article.

The produced clay body has characteristics such as favorable plasticity that contribute to its workability and allow it to be hand-thrown on a potter's wheel to form the final article, in addition to aiding in the design, prototyping, and development thereof.

### RANGES OF WATER

In some embodiments, the clay body may comprise a certain percentage by weight of water, before or after firing. In some embodiments, the clay body has a percentage of water by weight of at least 1%, at least 5%, at least 10%, at least 15%, at least 20%, at least 25%, at least 30%, or at least 35%. In some embodiments, the clay body has a percentage of water by weight of less than or equal to 40%, less than or equal to 30%, less than or equal to 25%, less than or equal to 20%, less than or equal to 15%, less than or equal to 10%, or less than or equal to 5%. Combinations of the above-referenced ranges are also possible (e.g., at least 10% and less than 30%). Other values and ranges are also possible, depending on methods of manufacture and shaping of the clay body.

### GLAZE

According to one or more embodiments, a glaze coating 30 may surround at least a portion of a surface of the clay body 20.

In some embodiments, the glaze coating may have a certain average thickness. In some embodiments, the glaze coating has an average thickness of at least 0.05 mm, at least 0.1 mm, at least 0.5 mm, at least 1.0 mm, or at least 1.5 mm. In some embodiments, the glaze coating has an average thickness of less than or equal to 2.0 mm, less than or equal to 1.5 mm, less than or equal to 1.0 mm, less than or equal to 0.5 mm, or less than or equal to 0.1 mm. Combinations of the above-referenced ranges are also possible (e.g., at least 0.05 mm and less than or equal to 2.0 mm). Other values and ranges are also possible.

The glaze coating may be selected to have approximately the same coefficient of thermal expansion as the clay body over the range of temperatures of use. The temperatures of use may range from less than room temperature to temperatures greater than 1000° F., and extending through normal cooking temperatures (ranging roughly from 200° F. to 500° F.). The range of temperatures of use include temperatures for uses, such as baking, roasting, fire-based cooking, grilling, frying, searing, poaching, slow-cooking, serving, etc.

Over a range of temperatures of use (e.g., between 40° F. and 1200° F.), the coefficient of thermal expansion of the glaze may be within at least 20%, at least 15%, at least 10%, at least 5%, or at least 1% of the coefficient of thermal expansion of the clay body. The similarity of the coefficients of thermal expansion allows the glaze to expand with the clay body during use to minimize cracking in the glaze.

The glaze coating 30 may comprise more than one glaze component. For example, the glaze coating may comprise a first clear glaze and a second stained glaze. The glaze may comprise CMC gum, a methylcellulose gum to aid in the brushing application.

### Methods FOR MAKING ARTICLES OF COOKWARE

According to certain embodiments, methods for making articles of cookware are disclosed. The method may comprise providing a clay body. The clay body may have a composition comprising components as described above. The clay body may be shaped, fired, and glazed to provide an article of cookware. The cookware may be custom designed collaboratively with a user.

The components of the clay body may be combined according to one or more methods to provide the clay body. According to some embodiments the individual components of the clay mixture may be mixed or blended together. The mixture may then be milled, in, for example, a pug mill. The water may then be added, according to proportions discussed above, to provide a wet mixture. The wet mixture may then be de-aired to eliminate air bubbles and provide a clay body ready to be shaped. According to one or more embodiments, a method for facilitating the production of clay-based articles of cookware may comprise the step of providing the clay body or clay mixture. Furthermore, the components of the clay mixture with or without added water may comprise a kit, according to one or more embodiments.

The clay body may be shaped into the form of the article, e.g., cookware. The nature of the clay body allows for the shaping to take place according to any of a variety of means available to a person of ordinary skill in the art. For example, the clay body may be shaped by throwing on a pottery wheel. The clay body may be shaped by hand building. The clay body may be molded (e.g., hand pressed in a mold or over a drape mold). The articles may be shaped by casting (e.g., slip-casting) or pressing (e.g., dry-pressing or ram-pressing). Shaping may further comprise a step of trimming the clay body with sharp-edged tools to provide a more finished shape. In some embodiments, further finishing (e.g., using diamond polishing pads) may take place after a final firing.

Where the clay body is thrown on a pottery wheel, pre-determined amounts by weight of clay may be shaped into a form having pre-determined general dimensions with the aid of custom measuring tools and jigs to facilitate the production of articles at a regular rate while still maintaining an individual, bespoke feel.

After the clay has been shaped into the form of an article of cookware, it may be fired. A period of time for drying may occur between shaping and firing. According to some embodiments, firing in a kiln may entail firing to cone 5 at a temperature of between 2000° F. and 2300° F.

According to one or more embodiments a two-stage firing process may take place. The first firing stage may be a bisque firing stage. The second firing stage may be a glaze firing stage.

According to one or more embodiments, during the first firing stage, the clay is fired in a kiln for 4 to 10 hours at between 150° F. and 250° F. The temperature may then be increased. The temperature may be increased at a rate of between 100° F./hr and 300° F./hr until reaching a temperature of between 1800° F. and 2000° F. The shaped clay body to cool for a period of at least 12 hours. During or at the end of the cooling period, a glazing step may be carried out.

According to one or more embodiments, during the second firing stage, the clay is fired at an increasing temperature from a starting temperature of at between 40° F. and 250° F. for a period of 6 to 10 hours until reaching between 2000° F. and 2300 ° F. The clay body is then allowed to cool for a period of at least 12 hours.

According to one or more embodiments, the clay body may be glazed, during, after or prior to one or more stages of firing. According to one or more embodiments the step of glazing may comprise a two-step process: applying a first clear glaze; and, applying a second stained glaze. The glaze may comprise CMC gum, a methylcellulose gum to aid in the brushing application. The glaze may be applied by brush or other means (dip, spray, etc.).

According to one or more embodiments, the step of glazing may occur after a first firing stage and before a second firing stage. For example, a glaze may be applied to the clay body (or a portion thereof) after a bisque firing stage. One or more coats of a first glaze may be applied allowing for a period of time for drying between coats. After the one or more coats of a first glaze are applied and allowed to dry, one or more coats of a second glaze may be applied, allowing again for a sufficient period of time for each of the one or more coats to dry. As discussed above, the first glaze may be a clear glaze, while the second glaze may be a stained glaze.

The compositions and methods described above facilitate individual custom designed articles of cookware that may match the particular needs and vision of a given user, most often a chef in a restaurant environment. The disclosed articles may be contrasted with other products intended for production and methods of production at scales that favor standardization over customization. According to certain embodiments, the disclosed articles are designed and developed to aid in allowing users to reach their full potential in the practice of their artistry.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article of cookware, comprising:
a clay body, wherein the clay body comprises:
water; and
a clay mixture, wherein the clay mixture comprises:
hectorite;
mullite;
petalite; and
a base clay.

2. The article of claim 1, wherein the base clay comprises aluminum (I) oxide (AlO₂) and silicon dioxide (SiO₂).

3. The article of claim 2, wherein the clay mixture comprises:
0.1% to 5% by weight hectorite;
0.1% to 5% by weight mullite;
40% to 60% by weight petalite; and
40% to 60% by weight base clay.

4. The article of claim 3, wherein the base clay comprises 20% to 50% by weight aluminum (I) oxide (AlO₂) and 30% to 70% by weight silicon dioxide (SiO₂).

5. The article of claim 4, wherein the base clay further comprises:
0.1% to 5% by weight potassium oxide (K₂O);
0.1% to 5% by weight calcium oxide (CaO);
0.1% to 5% by weight magnesium oxide (MgO); and
0.1% to 5% by weight titanium oxide (TiO₂).

6. The article of claim 5, wherein the base clay further comprises:
0.1% to 5% by weight iron oxide (Fe₂O₃).

7. The article of claim 1, wherein the clay body, prior to firing, comprises 1% to 40% by weight water and 60% to 99% by weight clay mixture.

8. The article of claim 1, further comprising a glaze coating on at least a portion of a surface of the clay body.

9-13. (canceled)

14. The article of claim 8, wherein the glaze coating and the clay body have approximately the same coefficient of thermal expansion.

15. (canceled)

16. The article of claim 1, the article of cookware is configured to tolerate temperatures greater than 1500° F.

17-20. (canceled)

21. A method for making an article of cookware, comprising:
providing a clay body, wherein the clay body comprises:
water; and
a clay mixture, wherein the clay mixture comprises:
hectorite;
mullite;
petalite; and
a base clay;
shaping the clay body; and
firing the shaped clay body to produce the article of cookware.

22-23. (canceled)

24. The method of claim 23, wherein the base clay comprises 20% to 50% by weight aluminum (I) oxide (AlO₂) and 30% to 70% by weight silicon dioxide (SiO₂).

25. The method of claim 24, wherein the base clay further comprises:
0.1% to 5% by weight potassium oxide (K₂O);
0.1% to 5% by weight calcium oxide (CaO);
0.1% to 5% by weight magnesium oxide (MgO); and
0.1% to 5% by weight titanium oxide (TiO₂).

26. The method of claim 25, wherein the base clay further comprises 0.1% to 5% by weight iron oxide (Fe₂O₃).

27. The method of claim 21, wherein the clay body, prior to firing, comprises 1% to 40% by weight water and 60% to 99% by weight clay mixture.

28. The method of claim 21, further comprising glazing the shaped clay body.

29. (canceled)

30. The method of claim 28, wherein the step of glazing comprises:
applying a first clear glaze to the shaped clay body after a first firing and before a second firing; and
applying a second stained glaze to the shaped clay body, after a first firing and before a second firing.

31. The method of claim 21, wherein the step of providing the clay body comprises:
mixing the clay mixture;
milling the clay mixture;
adding the water to the clay mixture to produce a wet mixture; and
de-airing the wet mixture to provide a clay body.

34. The method of claim 21, wherein the step of firing comprises firing at a temperature of between 2000° F. and 2300° F.

35. The method of claim 21, wherein the step of firing comprises:
firing the shaped clay body in a kiln for 4 to 10 hours at between 150° F. and 250° F.;
increasing the temperature at a rate of between 100° F./hr. and 300° F./hr. until reaching a temperature of between 1800° F. and 2000° F.;
allowing the shaped clay body to cool for a period of at least 12 hours;
firing the shaped clay body at an increasing temperature from a starting temperature of between 40° F. and 250° F. for a period of 6 to 10 hours until reaching a temperature between 2000° F. and 2300° F.; and
allowing the shaped clay body to cool for a period of at least 12 hours.
